(19) United States
(12) Patent Application Publication
(10) Pub. No.: US 2004/0023187 A1
(43) Pub. Date: Feb. 5, 2004

(54) Ultrasonic surgical dental tool and method of making same

(76) Inventor: Teresa R. Hickok, Bonita, CA (US)

Correspondence Address: LEWIS, RICE & FINGERSH, LC, ATTN: BOX IP DEPT., 500 NORTH BROADWAY, SUITE 2000, ST LOUIS, MO, 63102, US

(21) Appl. No.: 10/211,201

(22) Filed: Aug. 2, 2002

(51) Int. Cl. A61C 3/03

(52) U.S. Cl. 433/119; 433/165

(57) ABSTRACT

A dental tool for use with an ultrasonic transducer, includes an elongated unitary shaft member having a longitudinal axis, a proximal end and a distal end having an outer surface having a surface area configuration taken from the group consisting of cylindrical, spherical, teardrop, bell and conical, an attachment member at the proximal end to enable detachable attachment to an ultrasonic transducer; and a cutting surface at the distal end defined by a plurality of grooves on the outer surface forming cutting edges. The cutting surface is formed by running threads around the shank of the tool in one or both directions.

### FIELD OF THE INVENTION

This invention relates generally to ultrasonic dental tools and pertains more particularly to special ultrasonic dental tools and methods of making such tools for surgical treatment of periodontal disease.

### BACKGROUND

In the past decade, ultrasonic dental tools have come into greater use and are playing an ever-increasing role for drilling, cutting, shaping, cleaning and polishing teeth. Most of the devices used to prepare teeth have been powered by electric or air powered rotating motors. The tools useable with these powered prior art devices were limited to rotating drills, cutters, grinders and polishers. The ultrasonic powered dental tools of recent years have a different type of motion and have several advantages over prior tools for many applications. Among the advantages are that they are smaller, afford greater vision and precision and can be more easily manipulated in and around dental structures in the oral cavity.

The ultrasonic power units in use today have an entirely different type of motion than the rotary motion of air and electric motor powered units of the past. The motion imparted to the tool by an ultrasonic power unit is usually a very high frequency or velocity oscillation or reciprocation at the distal end of the tip of an otherwise stationery tool. The use of ultrasonic powered tools has resulted in the need for the development of entirely different types and sizes of tools than have existed in the past. While many tools have been developed and are available for use with ultrasonic power units, there is a need for additional tools designed and configured to perform new and different procedures.

Examples of ultrasonically powered instruments for dental use are disclosed in U.S. Pat. No. 4,019,254, issued Apr. 26, 1977 to Malmin, U.S. Pat. No. 5,094,617 issued Mar. 10, 1992 to Carr and PCT Publication WO 86/05967. With the exception of the first mentioned patent, all tools are formed with a shaft tapered to a point. More recent examples of improved tools are disclosed in the applicant's recently issued U.S. Pat. No. 5,836,765, issued Nov. 17, 1998, and U.S. Pat. No. 5,868,570 issued Nov. 12, 1998 to Hickok.

Ultrasonic tools, which have been developed in recent years, have begun to be used for many operations on teeth, bones, and soft tissue including dislodging and removal of dental material. These ultrasonic tools have been found to be particularly useful for scaling and cleaning. In many operations there is a need to clean and polish the furca and other areas of teeth for further treatment such as bonding restoratives to tooth structure. The cleaning and polishing of this area of a tooth can result in the reduction and often elimination of pockets by enhancing gum reattachment.

While many tools have been developed for use with ultrasonic transducers for dental work, it is apparent that many more procedures could be performed with the proper tools. Therefore, there is a need for improved ultrasonic dental tools formed of a suitable strong, flexible and durable heat resistant material with suitable configurations for performing various procedures in dentistry. There is particularly a need for improved ultrasonic dental tools having configurations than enable new and different procedures to be performed for removing and placing materials, precise removal of tooth structure and for cleaning and polishing teeth and supporting bone areas.

Periodontal disease affects many different areas in the oral cavity. These areas include the root area of the tooth, the bone in which the tooth is rooted and the gums around the tooth. Typical treatment involves removal of the diseased portion of the tooth or bone structure of these areas. This often involves curettage of the affected tissue, planing and smoothing of the root surfaces of the tooth and the surfaces of the bone. Pockets are often formed where an accumulation of calculus and other debris causes the gums to pull away from around the root and lower portion of the teeth. This must be cleaned away from the surface of the tooth and the surface smoothed in order for the gums to reattach to the tooth surface. In many operations there is a need to clean and polish the furca and other hard to reach areas of teeth for further treatment such as bonding restoratives to existing tooth structure. The cleaning and polishing of this area of a tooth can result in the reduction and often elimination of pockets by gum reattachment.

In the manufacture of these tools, it is necessary to create a surface on the working area of the tool to perform the necessary task. This usually requires roughening the tool surface to provide a cutting surface. In the past, the roughening of the tool surface has been accomplished by two methods, sand blasting, and the application of a diamond coating. The inventors have also created a technique wherein a knurling tool is used to create a cutting surface. This technique is disclosed in co-pending U.S. application Ser. No. 09/704,855 filed Nov. 2, 2002, entitled Ultrasonic Surgical Dental Tool Having a Rasp Tip.

The sandblasting technique is good in that it can be applied to any shape of tool or tip. However, it is limited in the degree of cutting surface that can be produced. Frequently a more aggressive cutting surface is desirable than can be produced with the sand blasting technique.

Diamond coating is capable of producing a sufficiently aggressive cutting surface but, has a number of drawbacks. One problem is that it is subject to chemical reactions from cleaning and sterilization agents commonly used in dentistry. As a result, they can rapidly deteriorate and fall apart. Another problem is that it defeats the object of micro-instrumentation because it involves the addition of material to the tool surface.

It would be desirable to have ultrasonic tools capable of placing or removing restorative materials, removing pulp stones, troughing for extra orifices, chasing calcified canals, precise elimination of tooth structure and finishing these areas of the teeth. Therefore, there is a need for an ultrasonic dental tool that has a tip that is structured and configured for finishing and polishing certain areas of a tooth internally, exteriorly or bone. The present invention satisfies these needs and provides related advantages as well.

### SUMMARY OF THE INVENTION

A primary objective of this invention is to provide an improved ultrasonic dental tool having a tip that is formed of durable high strength heat resistant material having a configuration for performing periodontal procedures.

In accordance with a primary aspect of the present invention a dental tool for use with an ultrasonic transducer comprises an elongated unitary shaft member having a proximal end and a distal end, attachment means at said proximal end to enable detachable attachment to an ultrasonic transducer; and a cutting surface at said distal end defined by a plurality of grooves forming sharp edges on said surface. Another aspect of the present invention a method of making an improved ultrasonic dental tool having a cutting surface including the steps of

### BRIEF DESCRIPTION OF DRAWINGS

The objects, advantages and features of this invention will be more readily appreciated from the following detailed description, when read in conjunction with the accompanying drawing, in which:

FIG. 1 is a side elevation view of an ultrasonic hand piece equipped with dental tool constructed in accordance with a preferred embodiment of the invention;

FIG. 2 is a side elevation view of the dental tool of Fig. in an intermediate stage of construction;

FIG. 3 is an a side elevation view of the finished dental tool of FIG. 1;

FIG. 4 is a side elevation view of an alternate embodiment of an ultrasonic dental tool of the invention;

FIG. 5 is a side elevation view of the finished dental tool of FIG. 4;

FIG. 6 is a view like FIG. 4 of another embodiment of an ultrasonic dental tool of the invention;

FIG. 7 is a side elevation view of the finished dental tool of FIG. 6;

FIG. 8 is an enlarged detail view of a cutting tip portion of a dental tool like that of FIG. 4 showing details of the cutting surface;

FIGS. 9-14 are enlarged detail section views of cutting tip portion of a series of dental tools like that of FIG. 4 showing details of different forms of the cutting edges on the surface; and

FIGS. 15-19 are enlarged detail partial views of cutting tip portion of a series of dental tool tips showing details of different configurations of tips for the tool.

### DETAILED DESCRIPTION OF PREFERRED EMBODIMENTS

The present invention will be described with reference to preferred embodiments of the invention as illustrated in the drawings. While this invention is described in terms of the best mode for achieving this invention's objectives, it will be appreciated by those skilled in the art that variations may be made in view of these teachings without deviating from the spirit or scope of the invention.

Referring to FIGS. 1, 2 and 3 of the drawings there is illustrated an exemplary embodiment of a tool for dental surgical operations and stages of its construction, in accordance with the present invention, designated generally by the numeral 10. The tool 10 is shown in FIG. 1 mounted in an end of an ultrasonic hand piece 12 in which is mounted an ultrasonic transducer which generates ultrasonic oscillations or vibrations transmitted to the tool. The ultrasonic transducer or motor mounted in the hand piece is connected by a conductor within a line 14 to a converter box (not shown). The line 14 may also contain a water line or tube for conveying water or other fluids to the working tip of the tool. The tool 10 may also be formed with means to get water or fluid to the working surface of the surgical tip of the tool. The ultrasonic transducer (not shown) within the hand piece is connected to a shaft (not shown) that extends from the front of the hand piece to which the tool is attached by a suitable detachable connection.

Referring to FIG. 1 of the drawings, an ultrasonic hand piece, designated generally by the numeral 8, is illustrated with an exemplary embodiment of a tool in accordance with the invention designated generally at 10, for dental operations shown attached to one end of the hand piece. An ultrasonic transducer or motor is mounted in the hand piece and is connected by a conductor within a line 11 to a converter box (not shown). The line 11 may also contain a water line or tube for conveying water or other fluids to the working tip. The tool 10 may also preferably be formed with means to get water or fluid to the working end or tip of the tool. The ultrasonic transducer (not shown) within the hand piece is connected to a shaft (not shown) that extends from the front of the hand piece to which the tool is attached by a suitable detachable connection.

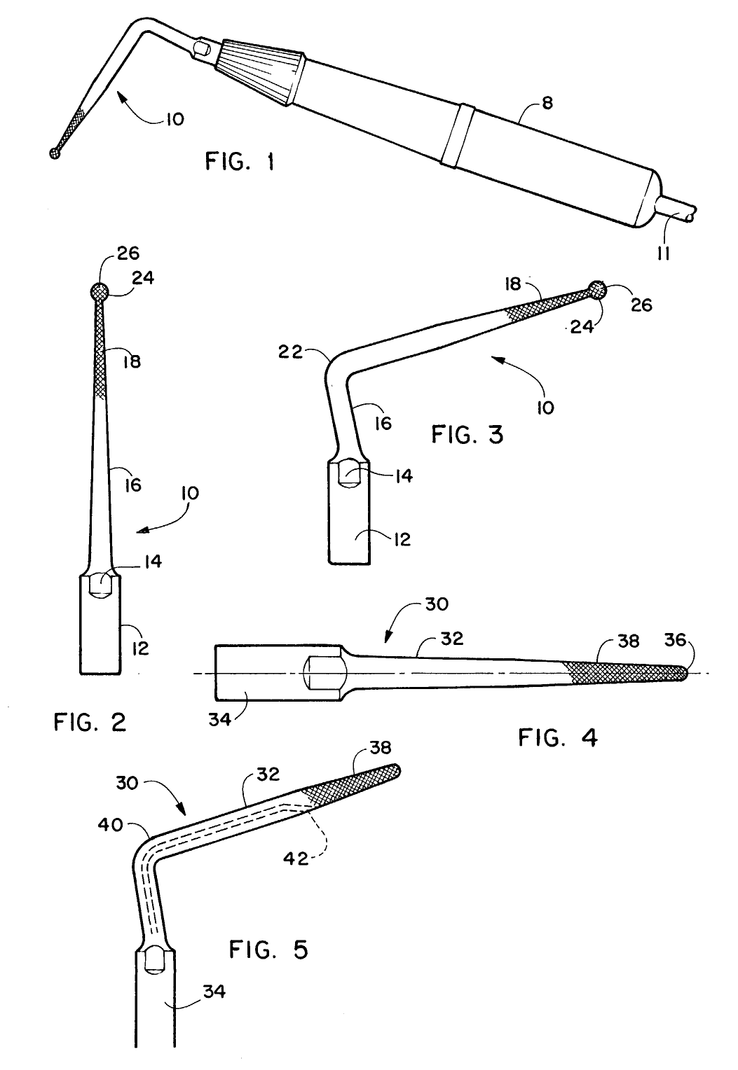

The tool 10 illustrated in FIGS. 1 and 2, is designed for performing any number of operations including the removal of restoratives, removal of post, breaking up of core materials, cleaning, cutting, shaping, finishing and polishing operations on teeth and bones. The tool 10 is designed and configured with a tip having a rounded or spherical surface configured and finished for performing a variety of dental procedures. The tool is also provided with a passage to convey water or other fluid to the working tip or surface of the tip. As used herein, the “working tip” refers to that part of the tool typically at the outer or distal end thereof adapted to be engaged in contact with the tooth or tissue for performing work. The tools are constructed with the shaft near the tip in a range of sizes from on the order of about 0.036 to 0.040 inch in diameter with the tip about 0.060 inch in radius. For this reason the tools are preferably constructed of a good grade of stainless steel alloy, and may also be constructed of other suitable materials such as a strong medical grade titanium alloy.

The tool is constructed in a series of steps forming an intermediate stage, as illustrated in FIG. 2 comprising elongated shaft 16 having connecting means 12 at a first or proximal end and a rounded or spherical tip with a rasp like cutting surface 18 at a second or distal end. The tool is first formed by machining from a high or medical grade of stainless steel or other suitable material into a basic configuration as illustrated. A finishing or cutting surface is formed on the working area of the tool. In accordance with the present invention, the surface is formed by selecting a threading tool and cutting one or more threads along the surface area to form the cutting surface. A threading tool on a machine such as a lathe can cut threads on any surface formed or generated by a radius about a common axis. The radius can be constant or it can be constantly or continuously changing along the axis of the tool surface.

Various surfaces can be generated by adjusting the pitch, depth or by using single, double, or triple lead thread. Other variables include the angle and spacing of the groove forming the threads. A combination of clockwise threads and counter clockwise threads can be used to create a cross hatching effect. After the tool has been formed as in FIG. 2 with the desired surface, it may be properly hardened and coated and used in that configuration or it maybe further formed with suitable bends and curves before coating and hardening.

The tool, as illustrated in FIGS. 1 and 3, is formed with a contra angled proximally and comprised of an elongated shank or shaft 16 having connecting means 12 at one or a proximal end for detachable attachment to a hand piece of an ultrasonic power unit. As shown in FIG. 3, tool 10 is preferably formed with an elongated tapered shank or shaft having a proximal portion or contra angled end and a distal portion or end 18 with a fairly sharp bend 22 between the ends. The proximal portion from the connector 12 and bend 22 is offset or angled from the axis of the connector. The curve or bend 22 is preferably closer to the connector end than the working tip end. This portion of the shaft is preferably about one fourth or 25% of the distance along the shaft from the connector and the working tip. This combination forms a contra angle that positions the tip for ease of positioning and manipulation by the user.

The distal portion of the shaft of the tool is substantially straight and tapers down in diameter from the bend to the working tip. The tool has a working tip 24 that preferably has a spherical configuration and a diameter that exceeds that of the shaft adjacent the tip. Spherical tip 24 is preferably larger in diameter than shaft 16 by factor of up to about two. The tool is preferably provided with a fluid passage extending the length thereof from the connector end to an outlet port 26 at the working tip. The fluid outlet may be directly at the tip or spaced a slight distance from the tip.

The shaft is bent so that the tapered tip portion is curved or bent at 22 in a direction away from the axis of the shank or shaft portion 16. In one preferred embodiment this portion is at an angle of preferably about 70° to 85°, extending away from the proximal end. However, it is also contemplated herein that said angle could be between 45° and 90° as well. The bends in the shaft may be greater or less than those illustrated and are designed to position the working tip at a convenient and comfortable working position relative to the hand piece for the user. It will be appreciated from the present disclosure that the selection of the angle is to some extent dependent on the particular use of the tool and also individual user preferences. In any event it is to enable the user to properly position the working tip as necessary within the oral cavity. Accordingly, the present invention contemplates that the tip maybe at any angle with respect to the shaft thereto, or it maybe collinear with the shaft, the selection of which is dependent on the location that the particular procedure is being performed.

The tool is formed with an elongated tapered shank or shaft 16 that is bent or shaped and configured to position the working tip at a desirable position relative to the hand piece. The shaft has a first bend about half way between the proximal or attachment end and the distal or working end. A second bend 22 is positioned between the first bend and the distal end so that the distal end portion is curved away from the primary axis of the shaft to form what is called a contra angle. The tip as used herein means that portion of the tool at the outer or distal end configured to have a working surface or edge.

The shaft of the tool may have a combination of cylindrical surface and a tapered surface, a uniform taper along its length or it may have a compound taper such that it tapers a slight degree along a first portion and tapers at a slightly higher angle along the remainder of the shaft. The overall tool is constructed and configured to be tuned to and be matched to the impedance of the ultrasonic generator.

The working tip 24 of the tool is shaped and configured to fit or position in a necessary work area and perform the necessary work on the selected tissue. The tool as shown has a somewhat spherical form, and is positioned or formed at the very outer end or tip of the shaft. The working tip begins to increase in diameter at the inner end from that of the shaft and increases to a maximum diameter at the center and decreases again down to minimum diameter at the very outer tip. The working tip is formed with a generally file or rasp cutting surface which is formed as previously discussed with or by a threading tool forming plurality closely spaced parallel grooves in the surface forming cutting edges at the surface of the tool between the grooves. A set of grooves may run in a single or both directions about the axis of the tool. The grooves may be formed of a generally V-shape or a U shape and form a sharp edge at the surface between the adjacent grooves. The sharpness of the cutting edges can be controlled by the spacing, angle and other configurations of the grooves.

Referring to FIGS. 4 and 5, a tool designated generally at 30 is illustrated and preferably formed in a manner similar to the FIG. 2 embodiment. The tool is constructed in a series of machining steps forming an intermediate stage, as illustrated in FIG. 4 with an elongated shaft 32 having connecting means 34 at a first or proximal end. The elongated shaft 32 is formed by machining into a combined cylindrical and tapered shank with a rounded or spherical tip 36 having substantially the same diameter as the shaft. A surface extending from the surface inward is formed with a rasp like cutting surface 38 by a threading tool as in the prior embodiment.

The tool is first formed by machining from a high or medical grade of stainless steel or other suitable material into a basic configuration as illustrated. The tool is formed with an elongated shank or shaft 32 having a proximal portion or end with a connector 34 and a distal working tip or end 36. The shaft is shown as substantially cylindrical for a major portion of the length and is tapered down to a rounded tip 36 at the distal end. A finishing or cutting surface 38 is formed on the working area of the tool adjacent the tip or distal end by selecting a threading tool and cutting one or more threads along a portion of the surface area from the tip to form the cutting surface. A threading tool can be used to cut threads on a curved surface formed or generated by a radius about a common axis. Various cutting surfaces can be generated by adjusting the pitch, depth and other parameters and by using single, double, or triple or other multiple lead threads. Other variables, as will be subsequently described, include the angle and spacing of the threads. A combination of clockwise threads and counter clockwise threads can be used to create a cross hatching effect. After the tool has been formed as in FIG. 4 with the desired surface, the tool may then be formed into any desired configuration with the desired curves and bends. After the tool is formed with suitable bends and curves it is then properly hardened and coated.

In one embodiment of the invention the tool is formed with proximal portion of the shank at the connector offset or angled from the axis of the connector. The shaft is formed with a fairly sharp bend 40 between the ends, preferably closer to the connector end than the working tip end. This combination, as in prior embodiments, forms a contra angle that positions the tip for ease of positioning and manipulation by the user. The distal portion of the shaft of the tool is substantially straight and tapers down in diameter from the bend to the working tip 36 that preferably has a semi-spherical configuration and a diameter that is substantially the same as that of the shaft adjacent the tip. The tool is preferably provided with a fluid passage extending substantially the length thereof from the connector end to an outlet port 42 positioned at or near the working tip. The outlet port is positioned relative to the tip to flow a fluid such as water onto the tip during operation.

The shaft is first bent adjacent the connector away from the axis of the connector at about five to about fifteen degrees. It is then bent so that the tapered tip portion is curved or bent at 40 in a direction away from the axis of the shank or shaft portion at an angle of between about 45° and about 90° and preferably about 70° to 85°, extending away from the proximal end. This configuration forms a contra angle and positions the working tip at a convenient and comfortable working position relative to the hand piece for the user. It will be appreciated that the selection of the angle is to some extent dependent on the particular use for which the tool is designed. Also it will depend on individual user preferences to enable the user to properly position the working tip as deemed necessary within the oral cavity. Accordingly, the present invention contemplates that the tip maybe at any angle with respect to the shaft thereto, or it may be collinear with the shaft, the selection of which is dependent on the location that the particular procedure is being performed.

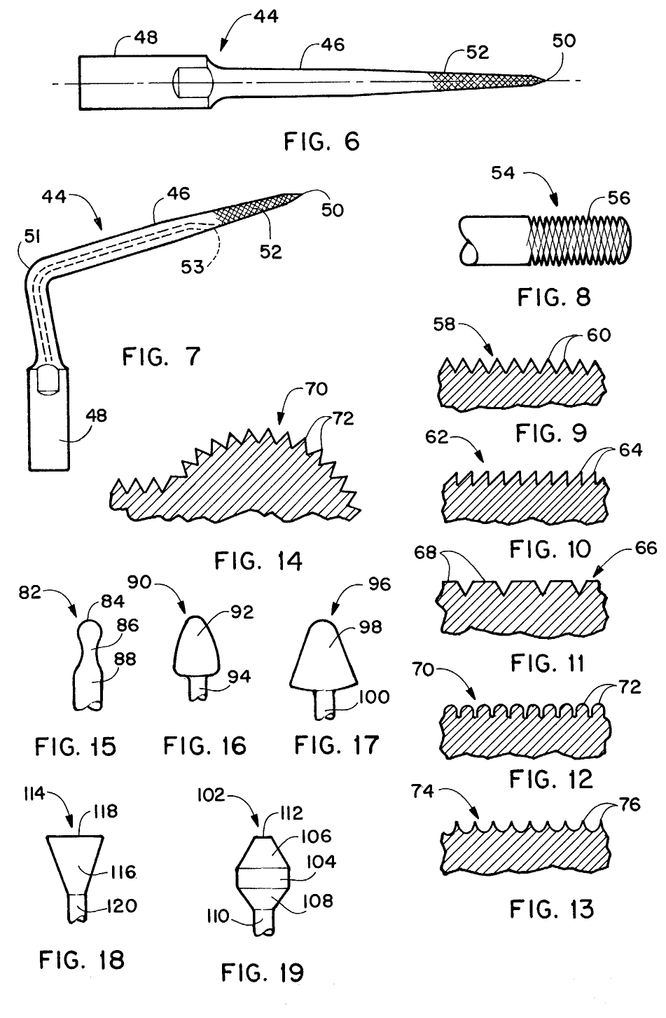

Illustrated in FIGS. 6 and 7, is a tool designated generally at 44 formed in a manner similar to that described with respect to the prior embodiments. As in prior embodiments, the tool is constructed in a series of machining steps forming a substantially straight tool in an intermediate stage, as illustrated in FIG. 6. The tool is formed with an elongated straight shaft 46 having connecting means 48 at a first or proximal end and a working end or tip at 50. The elongated shaft 46 is formed by machining into an elongated substantially cylindrical shaft along a major portion and tapereing down at the distal end to a conical or sharp tip or point 50. A surface area extending from the tip inward is formed with a rasp like cutting surface 52 by a threading tool as discussed in the prior embodiments and more fully discussed hereinafter. The overall tool is first formed by machining from a suitable material such as a medical grade of stainless steel or other suitable material into a basic configuration as illustrated in FIG. 6. The tool is initially formed with an elongated substantially straight shank or shaft 46 having a connector at a proximal portion or end with a working tip at a distal end. The shaft is shown as substantially cylindrical for a major portion of the length from the connector and is tapered down to a sharp or pointed tip at the distal end.

In one preferred embodiment of the invention the tool is formed with proximal portion of the shank at the connector offset or angled to one side of the axis of the connector. The shaft is then formed with a fairly sharp bend 51 between the ends, preferably near the connector end and away the working tip end. The shaft is bent back across the axis of the connecter to the opposite side to the sharp bend. This combination, as in prior embodiments, forms a contra angle that positions the tip to enable easier positioning and manipulation by the user. The distal portion of the shaft of the tool is preferably substantially straight and tapers down in diameter from the bend or alternatively a short distance from the bend to the working tip 50. The wording tip preferably has a sharp or pointed tip at the distal end. The tool is preferably provided with a fluid passage extending substantially the length thereof from the connector end to an outlet port 53 positioned at or near the working tip. The outlet port is positioned relative to the tip to flow a fluid such as water onto the tip during operation.

A finishing or cutting surface is formed on the working area of the tool at and adjacent the tip or distal end by selecting a threading tool and cutting one or more threads along a portion of the surface area at the tip to form the cutting surface. A threading tool can be used to cut threads on any curved surface formed or generated by a radius about a common axis. Various cutting surfaces can be generated by selecting the pitch, depth or by using single, double, or triple lead thread. Other variables, as will be subsequently described, include the angle and spacing of the threads. A combination of clockwise threads and counter clockwise threads can be used to create a cross hatching effect. After the tool has been formed as in FIG. 6 with the desired surface, the tool may be used as is or formed into another desired configuration with the desired curves and bends. After the tool is formed into the desired configuration with suitable bends and curves, if any, it is then properly hardened and coated.

Referring to FIG. 8, an enlarged diagrammatical illustration of the cutting surface of a cutting tip 54 is illustrated. A cross hatched cutting surface 56 is illustrated that is produced in accordance with steps of the present invention by selecting a thread cutting tool and cutting one or more threads in a first direction along the surface of the tip of the tool. Thereafter, the thread cutting tool is used to cut one or more threads in an opposite direction along the surface of the tool. The cutting edges on the surface can be made fine or coarse by adjusting the parameters of the threads. Adjustable parameters include single, double or triple lead, pitch, depth and angle.

FIG. 9 shows a side section view or profile of standard symmetrical threads on a cutting surface 58 of a tool. The threads are shown with adjacent grooves intersecting at the tool surface forming a series of adjacent v-shaped cutting members or edges 60. As will be appreciated, the grooves forming the cutting edges can be shallower or deeper and of different angles to adjust the size and sharpness of the cutting elements.

FIG. 10 illustrates a side section view or profile like FIG. 9 of non-standard or non-symmetrical threads on a cutting surface 62 of a tool. The threads are shown with adjacent grooves intersecting at the tool surface forming a series of adjacent triangular-shaped cutting members 64. As shown, the grooves forming the cutting edges have steeper walls on one side than the other. This structure would provide greater cutting action in one direction than the other along the axis of the shaft. The grooves can be shallower or deeper and of various different angles to adjust the size and sharpness of the cutting elements in selected directions.

In FIG. 11 is illustrated a section side view or profile like FIG. 10 of another modification of threads on or forming a cutting surface 66 of a tool. The pitch is such that the threads are shown with adjacent grooves intersecting only the tool surface and not adjacent grooves, forming a series of adjacent flat topped cutting members 68. Each cutting member has two cutting edges. As shown, the grooves are spaced apart forming the cutting edges less sharp than the prior embodiments. This structure would provide less aggressive cutting action than the prior embodiment. It can be formed with greater cutting action in one direction than the other along the axis of the shaft. The grooves can be shallower or deeper and of various different angles to adjust the size and sharpness of the cutting edges or elements.

FIG. 12 illustrates a section side view or profile like FIG. 10 of another modification of threads on or forming a cutting surface 70 of a tool. The pitch is such that the threads are shown with adjacent grooves intersecting only the tool surface and not adjacent grooves, forming a series of adjacent somewhat rounded topped cutting members 72. Each cutting member is somewhat rounded at the outer surface or at the intersection with the outer surface. Each member has two somewhat rounded cutting edges. The grooves can be closer together so that they intersect at the outer surface in a rounded configuration. This structure would provide less aggressive cutting action than the prior embodiment. It can be configured to perform more of a polishing than a cutting saction. The grooves can be shallower or deeper and of also of various different angles to adjust the size and sharpness of the cutting edges or elements.

FIG. 13 illustrates a view like FIG. 12 of another modification of threads on or forming a cutting surface 74 of a tool. The pitch is such that the threads are shown with adjacent grooves having a generally U shape at the root and intersecting at the tool surface, forming a series of adjacent sharp top cutting members 76. Each cutting member is somewhat knife edge like at the outer surface or at the intersection with the outer surface. The grooves can be closer together or farther apart to adjust the cutting edge. This structure would provide a much more aggressive cutting action than the prior embodiments. The grooves can be shallower or deeper and of also of various different angles to adjust the size and sharpness of the cutting edges or elements

Referring finally to FIG. 14, there is shown a side section view or profile of standard symmetrical threads on a curved or rounded cutting surface 78 of a tool. The threads are shown starting substantially at the very end or tip of the shaft with adjacent grooves intersecting at the tool surface forming a series of adjacent v-shaped cutting members or edges 80. As will be appreciated, the grooves forming the cutting edges can be shallower or deeper and of different angles as in prior embodiments to adjust the size of the cutting elements. This further illustrates that the cutting surface can be formed in accordance with the present method on any curved surface having a substantially uniform radius around its axis at any position along the shaft.

As previously discussed, the tip area of the tool may have any number of configurations to achieve optimum performance for selected applications. A number of examples of tip configurations are illustrated in FIGS. 15-19. These are merely intended to be exemplary and not exhaustive.

FIG. 15 illustrates a tip generally at 82 having a generally teardrop configured end portion 84 with a necked down portion 86 on the end of a shaft 88. A cutting surface as previously described will be formed on the surface. The necked portion has a configuration enabling it to be used in cutting and shaping convex curved surfaces.

FIG. 16 illustrates a tip generally at 90 having a generally round outermost end with a somewhat teardrop configured body portion 92 rounding down to the end of a shaft 94. The tip will be formed with a cutting surface as previously described on the surface enabling it to be used in cutting and shaping concave curved surfaces.

FIG. 17 illustrates a tip generally at 96 having a generally round outermost end with a somewhat bell shaped or configured body portion 98 rounding down to the end of a shaft 100. The tip will be formed with a cutting surface as previously described on the surface enabling it to be used in cutting and shaping various surfaces including flat and concave curved surfaces.

FIG. 18 illustrates a tip generally at 102 having a body configured with a generally cylindrical center portion 104 between two frustums 106 and 108 of a cone to the end of a shaft 110. The tip will be formed with a cutting surface as previously described on the surface enabling it to be used in cutting and shaping various surfaces including flat and concave curved surfaces. The body is illustrated to have a blunt or flat circular end 112 but, it may be semispherical or pointed (conical).

FIG. 19 illustrates a tip generally at 114 having a body 116 configured with a generally as a frustum of a cone a having blunt or flat circular end 118. The body is formed to the end of a shaft 120. The tip including the end surface will be formed with a cutting surface as previously described. The tip is configured enabling it to be used in cutting and shaping various surfaces including flat and concave curved surfaces.

Those skilled in the art will understand that the invention provides great flexibility to the user in being able to deliver a stream of fluid to the working area through the tip. For example, a host of chemicals can be delivered at precise points or to specific areas of the oral cavity in selected dosages. This opens up various methods and procedures capable of being performed with the invention. Although water may be delivered to the work area at the spherical tip, for cooling the tool or tooth, or for rinsing away debris, additional, various chemicals or even drugs can be delivered to the working area. For example, antibiotic or antiseptic solutions, or even fluoride solutions can be directed at a specific portion of tooth at or below the gum-line. For example, as shown in FIG. 3, a fluid passage extends through the tool and terminates at port 26 at the spherical tip 24. This allows fluid to be delivered as close as possible to the working point or contact point of the tool with the tooth or tissue.

Although it is contemplated herein that port 26 (FIG. 3, for example) is proximate the center of the tip, it is understood that the port can be at any other suitable location on or near the spherical tip, so long as fluid is conveniently delivered at or near the working or contact surface between the spherical tip and the tooth.

It is contemplated that a set of the tools will be provided having lengths, and angles that may vary with the lengths and shape of the cutting surface and the area of the oral cavity to be worked on. The cutting surface will have a length may vary between about two and about four times the diameter of the shaft. Exemplary dimensions of a typical exemplary embodiment are with a total length of the tool of about 1.9 inches with the shaft and tip having a length of approximately 1.5 inches. In one embodiment, the shaft has a short cylindrical portion of approximately 0.30 inches from the connecting member and a taper from about 0.085 down to 0.40 proximate the center thereof and further tapering from that point to approximately the juncture of the working tip. An exemplary working tip of any of the embodiments may have a cutting surface length along its axis of about 0.375 with a diameter of about 0.085. It will be appreciated that these may vary to meet the particular needs of the particular application.

The tools in accordance with the invention may be constructed of a good medical grade of stainless steel or, any other suitable material such as a titanium alloy of a medical grade. Suitable stainless steels include 13-8Mo and 17-4PH. As used herein, a “medical grade alloy” refers to a material that may be used in contact with food and with a patient's body without undergoing a chemical reaction. A particularly suitable titanium alloy is identified as 6AL/4V ELI & CP Grade 4, which is available from President Titanium of Hanson, Mass. This alloy has been demonstrated to be sufficiently hard, durable and flexible to resist breakage under normal use. It has also been found to withstand heat for short durations of use in the absence of a cooling fluid without burning or melting. Tools can be made smaller with the titanium alloys than have ever been achieved before with the stainless steels. They can be made very small with very small tips that will withstand the rapid buildup of heat normally encountered in orthodontic applications, especially when ultrasonic transducers are used. The small and thin tip design affords greater access to confined areas.

The tools may also be made of titanium and various alloys thereof as disclosed in my U.S. Pat. No. 5,836,765, incorporated herein by reference as though fully set forth. A titanium alloy that the inventor has found preferable in the present and similar applications is identified as 6AL/4V ELI & CP Grade 4 and is available from President Titanium of Hanson, Mass. The inventor has found this material to be sufficiently hard, durable and flexible to resist breakage under use. Likewise, various coatings may be applied to the tip to achieve its purpose.

The tools are formed by machining on a lathe or milling machine or combinations thereof. The tools, after formation, may go through various hardening and other treatment procedures before use such as disclosed in my U.S. Pat. No. 5,1704,787, incorporated herein by reference as though fully set forth. The abrasive or cutting surfaces of the tools may also be coated with a thin coating of a metal nitride such as disclosed in the aforementioned '787 patent.

In general, the preferred overall process for manufacturing the tips is as follows. A suitable stock is selected and an ultrasonic dental tool is manufactured typically by machining to form the shaft with connector and tip of the desired configuration. The abrasive or cutting surface is formed at the outer tip by a machining procedure to cut the grooves and form the cutting edges. The shaft is then bent into the proper or desired shape or configuration to orient and position the tip as desired. The next step in the process is to heat treat the steel after the roughing step to achieve a Rockwell-C hardness rating preferably or the order of about 40-42. Heat treating is a well known process that involves heating to a selected temperature and cooling of a metal at a controlled rate in the solid state for the purpose of obtaining certain desirable properties including increased hardness. A coating or coatings may be applied after the hardening process.

A metal nitride coating may be applied to the roughened outer surface. Preferably, the metal element is selected from the group consisting of Zirconium (Zr) and Titanium (Ti). Between a Ti—N and Zr—N coating, the latter is the hardest at about 3000 Vickers while the former is about 2800 Vickers. Either metal nitride provides a very hard surface tip with far less cost than those using diamonds. Further, one can expect long wear from tips created by the process of this invention because Ti—N and Zr—N are both highly resistant to abrasion and corrosion.

When the heat treating is followed by the application of a metal nitride coating the result is an extremely hard tip having very desirable cutting abilities. The coating may be applied by any well-known technique in the art. While not desiring to be limited to any particular method of coating, the inventors have discovered that the well-known technique of using physical vapor deposition equipment employing cathodic arc techniques is a satisfactory way to deposit thin films of the metal nitrides on dental surgical tips. The coating is preferably applied very thinly so that its average thickness is about 0.0002 inches. An advantage of such a thin coating is that very small diameter tips can be created that are extremely hard and yet abrasive. Such small diameter tips are desirable for microsurgery.

In operation, the tools described herein were developed predominantly for the periodontal treatment in root surfaces, soft tissue, and bone. The fine sharp cutting surfaces of the present tools can plane and abrade cementum and curette and contour the gingival tissue and alveolar bone. These tools enable an easier more efficient removal of diseased tooth and bone tissue and creation of smoother contoured surfaces than the prior art. The configuration of the shaft of the tool with bends and curvatures enable them to be positioned and used in unusually close quarters in the oral cavity. In view of the above description, it is possible that numerous modifications and improvements will occur to those skilled in the art, which are within the scope of the appended claims. While the tools of the present invention were designed and developed for surgical treatment of periodontal disease, they may be used for other purposes. For example, they may be utilized for many orthopedic and other similar surgical procedures.

Therefore, this invention is not to be limited in any way except by the appended claims.

I claim:

1. A dental tool for use with an ultrasonic transducer, the tool comprising:
an elongated unitary shaft member having a longitudinal axis, a proximal end and a distal end having an outer surface;
attachment means at said proximal end to enable detachable attachment to an ultrasonic transducer; and
said outer surface at said distal end having at least a first helical groove extending around said shaft and along the axis of said shaft forming cutting edges on said surface.

2. The tool of claim 1, further comprising at least a second groove said outer surface at said distal end.

3. The tool of claim 2, wherein one of said first groove and said second groove extending about said shaft in a clockwise direction and the other of groove and said second groove extending about said shaft in a counterclockwise direction along said longitudinal axis

4. The tool of claim 3, wherein said grooves have a generally V-shape.

5. The tool of claim 2, wherein said wherein said grooves are parallel to one another.

6. The tool of claim 1, wherein said groove has a generally V-shape.

7. The tool of claim 6, wherein said cutting edges are formed by intersection of adjacent grooves.

8. The tool of claim 6, wherein said cutting edges are formed by intersection of said groove with said shaft surface.

9. The tool of claim 1, wherein said outer surface is generated by a radius from a common longitudinal axis and having a surface area configuration taken from the group consisting of cylindrical, spherical, teardrop, bell and conical.

10. The tool of claim 9, wherein said outer surface is generated by a constantly changing radius along said common longitudinal axis.

11. The tool of claim 10, wherein said outer surface having a generally football configuration.

12. The tool of claim 10, wherein at least a portion of said outer surface having a semi-spherical configuration.

13. The tool of claim 10, wherein at least a portion of said outer surface having a tapered configuration.

14. The tool of claim 9, wherein at least a portion of said outer surface having a cylindrical configuration.
wherein said wherein said tip extends at an angle of between about 30 and 60 degrees to said shaft.

15. The tool of claim 9, wherein said shaft has at least one bend between said attachment means and said distal end so that said distal end extends at an angle to said axis.

16. The tool of claim 15, wherein said wherein said tip extends at an angle of between about 30 and 60 degrees to said shaft.

17. A dental tool for use with an ultrasonic transducer, the tool comprising:
an elongated unitary shaft member having a longitudinal axis, a proximal end and a distal end, said shaft tapering from a larger diameter at said proximal end to smaller diameter at said distal end, said distal end having an outer surface generated by a radius from a common longitudinal axis;
said outer surface having at least a first helical groove extending around said shaft and along the axis of said shaft forming cutting edges on said surface.

18. The tool of claim 17, wherein said outer surface on said distal end having a configuration taken from the group consisting of cylindrical, spherical, teardrop, bell and conical.

19. The tool of claim 17, wherein said outer surface is generated by a constantly changing radius from said common longitudinal axis

20. The tool of claim 19, wherein said outer surface having a generally football configuration.

21. The tool of claim 19, wherein at least a portion of said outer surface having a semi-spherical configuration.

22. The tool of claim 19, wherein at least a portion of said outer surface having a tapered configuration.

23. A method of making a dental tool for use with an ultrasonic transducer, comprising the steps of:
providing an elongated unitary shaft member having a longitudinal axis, a proximal end and a distal end, said shaft tapering from a larger diameter at said proximal end to smaller diameter at said distal end, said distal end having an outer surface generated by a radius from a common longitudinal axis; and
providing said outer surface at said distal end, with at least a first helical groove extending around said shaft and along the axis of said shaft forming cutting edges on said surface.

24. The method of claim 23, wherein said step of providing said elongated unitary shaft member comprises providing said shaft with an outer surface generated by a radius from a common longitudinal axis.

25. The method of claim 24, wherein said step of providing said outer surface comprises providing said surface generated by a constantly changing radius along said common longitudinal axis.

26. The method of claim 24, wherein said step of providing said outer surface comprises providing said surface having a generally football configuration.

27. The method of claim 24, wherein said step of providing said outer surface comprises providing said surface having a generally semi-spherical configuration.

28. The method of claim 23, wherein said step of providing said outer surface with at least a first helical groove extending around said shaft comprises providing a threading tool and cutting said first helical groove with said threading tool along the axis of said shaft forming cutting edges on said surface.

29. The method of claim 28, further comprising the step of providing said outer surface with at least a second helical groove extending around said shaft and along the axis of said shaft forming additional cutting edges on said surface.

30. The method of claim 23, wherein said step of providing said outer surface with at least a second helical groove comprises providing said second helical groove extending around the axis of said shaft in a direction opposite said first helical groove.
